(19) United States
(12) Patent Application Publication
(10) Pub. No.: US 2008/0164329 A1
(43) Pub. Date: Jul. 10, 2008

(54) Voting Apparatus and System

(76) Inventors: Victor Piorun, Nederland, TX (US); Merwyn Walther, Abington, PA (US); Ronald Nicholson, Conshohocken, PA (US)

Correspondence Address: PAUL AND PAUL, 2000 MARKET STREET, SUITE 2900, PHILADELPHIA, PA, 19103, US

(21) Appl. No.: 11/969,608

(22) Filed: Jan. 4, 2008

Related U.S. Application Data
(60) Provisional application No. 60/883,364, filed on Jan. 4, 2007.

(51) Int. Cl. G07C 13/00

(52) U.S. Cl. 235/50 B

(57) ABSTRACT

An apparatus that monitors the voter's actions while he or she votes, with tests for applied pressure, rapid and deliberate motion, and range of motion, within a limited time frame and designated area, to thereby generate electronic data directly and simultaneously from the voter's hand motion and thus accurately determine the voter's intent.

### CROSS REFERENCE TO RELATED APPLICATIONS

This application is a non-provisional of and claims the priority of U.S. provisional application for patent No. 60/883,364, filed on Jan. 4, 2007, the entirety of which is incorporated herein by reference.

### BACKGROUND OF THE INVENTION

1. Field of the Invention

This invention is an improved voting apparatus, wherein the voter's motions while voting are analyzed in order to confirm his/her intentions and the accuracy of the votes.

2. Discussion of the Prior Art

Since this invention addresses the problems in electronic voting systems only recently surfacing, and is specific to modern computer systems used in voting; one can not expect much applicable prior art.

Many types of paper ballot are known in the prior art. It is not the intention herein to patent a paper ballot, itself; but a device that monitors the voter's actions while filling out that ballot, in order to confirm timeliness and intent on the part of the voter.

Machines that scan documents or otherwise “read” a ballot are also known in the prior art. It is not the intent of this invention to claim such devices. However, these devices are limited to reading the marked ballot after the fact. The present invention reads the voter's hand actions while the voting is being done, and therefore, confirms the voter's intent. It does not rely on the markings, themselves. It also filters out (ignores) markings not made by the voter.

Computer systems and input devices are of general application by nature. We believe the application of a computer system to vote tabulation is known in the prior art. It is not intended here to broadly patent the use of a computer system in vote processing.

None of the prior art show a device that monitors the voter's actions during the voting process and analyzes and confirms the voter's intentions.

U.S. Pat. No. 7,048,186, issued on May 23, 2006, to Chandler, et al., enumerates a multitude of variations by which a vote may be directly entered by pointing device, in much the same way as votes are entered by lever in conventional machines. The enumerated pointing devices include stylus, punching device, marking device, and finger. In some cases, an actual ballot is created (written or punched). However, (as with other voting systems) the vote is tested only quantitatively, not qualitatively; that is, the vote is merely detected, not tested for intent. There is no test of the vote-marking for duration, repeated motion, deliberate pressure, time frame, etc., that characterize our invention. Furthermore, an implementation in which the input device is an analyzing apparatus that may in turn incorporate a pointing device or a pointing device used in conjunction with an analyzing apparatus is not disclosed.

U.S. Pat. No. 7,100,828, issued on Sep. 5, 2006, to Cummings, shows a system whereby a ballot may be either marked manually or machine-marked in a voting station. There is no requirement for marking every ballot by hand, or any qualitative tests of the vote-marking process.

The need persists in the art for a voting apparatus that analyzes the voter's actions during the voting process to determine that the voter's actions meet predetermined criteria relating to one or more properties such as, for example, duration, repeated motion, deliberate pressure, time frame, etc. in order to confirm the voter's intentions. The advantages of the present invention are further made apparent by the detailed description of the invention and the attached drawings that follow herein.

### SUMMARY OF THE INVENTION

This invention relates to systems of recording the votes in an election process.

A ballot is the tangible instrument used to indicate a voter's choices in an election process. It is usually made of paper and votes are indicated by marking device (such as a pencil or pen), but another substrate may be used and another marking method (such as punching holes in the substrate) may be employed. Within the scope of this disclosure, the term, ‘paper ballot’ shall be construed to mean a ballot of any substrate that is marked in any way. In addition to indicating the voter's choices initially, the ballot is a permanent record of the votes, to be used in recounts and in the event of data loss.

It has recently been popular for mechanical, electro-mechanical and/or electronic machines to replace the traditional paper ballots heretofore used to record the votes in an election process.

The reasons for this include making the voting process more secure, making tabulation more accurate, getting results more quickly, and making vote counting less laborious.

Problems with lever-operated machines and advances in computer technology have led to more sophisticated machines, employing computers, touchscreens, and other state-of-the-art inventions.

These machines have introduced various attendant problems and shortcomings. Some voting systems are intimidating or difficult to understand. Many do not generate hard-copy (usually paper) records of the vote. Many print a hard-copy record after the fact. Such systems can be easily compromised. Computer systems have malfunctioned (crashed), causing the loss of votes. Printing devices have jammed and run out of paper or ink. Some manual ballots contain ambiguous votes when not marked clearly.

Systems that used punched ballots have produced unreliable results (‘hanging’ or ‘pregnant’ chads, etc.). Touchscreen-based systems require constant maintenance, including cleaning and calibration. Many voting machines do not offer the voter proper confirmation—assurance that his/her ballot is being recorded properly.

The public has become increasingly dissatisfied with, and mistrusting of, such machines; and solutions to the problems have been actively sought.

The most accurate indication of the voter's preferences is the old-fashioned paper ballot. However, when paper ballots are used, the advantages of an automated system are usually lost. Also, there has been no way to authenticate that the ballot accurately represents the voter's choices and is properly filled out, other than to look over the voter's shoulder as he/she votes. We believe this invention does the next best thing.

This invention facilitates the return to the traditional and reliable paper ballot voting method, by providing a machine to record the ballot positively, accurately, and automatically when used alone or within a larger system.

This invention is an apparatus that monitors and analyzes the voter's hand motions while he/she fills out a traditional paper ballot, and generates electronic data corresponding to the votes. This invention automatically produces electronic data that is used to automate the vote count, while insuring that a paper record is simultaneously, independently, and accurately generated.

Instead of generating the ballot artificially from electrical or mechanical data entered via levers, pushbuttons, touchscreens, and so forth; this invention requires that the voter directly create the ballot in his/her own hand, and it simultaneously generates the electronic data directly from the voter's actions in filling out the ballot.

Instead of generating electronic data by reading the markings on the ballot after the fact, when the ballot may be altered or incorrectly filled out; this invention monitors the voter's action in filling out the ballot and records the data directly from these actions, and not from the markings.

In other words, the data is not derived from the ballot markings, themselves, and the ballot markings are not generated by data entered mechanically. Instead, both the electronic data and the paper ballot are generated directly by the voter at the time of voting.

This apparatus replaces conventional input devices, such as levers, mechanical switches, sensors, positioning devices, styli, trackballs, computer mice, joysticks, pushbuttons, etc. that input directly to the vote-processing machine or system. This invention, in combination with its own appropriate sensing devices, analyzes the voter's actions and provides an output signal to the voting machine or data processing system in lieu of, or in combination with, other direct input devices.

This invention is distinguished from similar voting systems currently in use and the prior art by embodying one or more of the following specified features or objects:

1. The invention provides an apparatus to analyze the voter's actions as the vote is made, and record the voter's choices thus determined.

2. The invention provides an apparatus to simultaneously mark a paper ballot and generate data used to automate the count.

3. The invention provides an apparatus to independently mark a paper ballot and generate data used to automate the count.

4. The invention provides a method of ensuring that the voter is casting a vote that is authentic.

5. The invention provides a method of ensuring that the voter is casting a vote that is intentional.

6. The invention provides a method of ensuring that the voter is casting a vote that is deliberate.

7. The invention provides a method of ensuring that the voter is casting a vote that is accurate.

8. The invention provides a method of ensuring that the voter is casting a vote that is unambiguous.

9. The invention provides a method of ensuring that data is derived only from ballot markings made by the voter at the time that the vote is cast, and not from any other marks or alterations made to the ballot.

10. This invention, by monitoring the voting process, can detect errors and omissions in time to correct them.

11. This invention replaces other forms of direct input to the voting machine or data processing system with a more failsafe input device that tests for intent on the part of the voter.

12. This invention, when used as part of a comprehensive system, may provide additional safeguards and features; including, but not limited to:
a. Confirming the voter's eligibility.
b. Detecting duplicate voters.
c. Providing unique identifier markings on the ballot; checking for missing or extra ballots.
d. Detecting missing or ambiguous votes, errors and/or omissions.
e. Insuring that the recorded data matches the actual ballot markings.
f. Confirming the ballot to the voter.

13. This invention provides a voting system that is more precise, secure, resistant to tampering and less susceptible to creative interpretation.

These and other objects of the present invention will be apparent from the detailed description of the invention and the attached drawings that follow herein.

### BRIEF DESCRIPTION OF THE DRAWINGS

FIG. 1 shows a diagrammatic view of one embodiment of the present invention.

FIG. 2 shows a diagrammatic view of another embodiment of the present invention.

FIG. 3 shows a schematic representation of one possible implementation of the embodiment shown in FIG. 1.

### DETAILED DESCRIPTION OF THE INVENTION

In its preferred embodiment, a paper ballot is presented to the voter. This ballot is held in position over a platen during the voting process. The vote is made by filling-in a rectangular check-box with a pencil or other marking device, in the same manner as commonly used in electrically-graded tests. An optional transparent overlay panel with apertures aligning with the checkboxes may be used to protect the ballot from extraneous marks and to guide the voter in filling out the desired check-box more accurately. This device may also be used to allow the visually-impaired voter to vote independently and privately. The overlay panel may contain larger openings for entry of write-in candidates.

The platen contains sensors to detect the markings made by the voter. The voter must move a marking device, such as a pencil or pen, up and down repeatedly and with significant pressure in a specified area and within a short timeframe in order to fill-in the checkbox and register the vote. The sensors in the platen are connected to a device that detects such motion.

There may be only one sensor under each checkbox on the ballot. In this case, the device will register a vote if pressure is applied to a particular sensor over a period of time, consistent with the box being filled-in deliberately.

A more failsafe implementation employs two or more sensors under each box, and then the device registers a vote when pressure is applied to the multiple sensors in rapid alternation within a discrete time period.

The sensors may be serrated and interleaved, or more sensors may be used, in order to increase the sensitivity and accuracy. For example, multiple sensors may be wired as two groups and interspersed, so that as the checkbox is marked, a series of alternating pulses is generated upon each stroke. Another implementation is to use multiple discrete sensors and monitor each separately.

Additional sensors may be placed at the vertical extremes of the checkbox, in order to determine that the voter has marked the entire box. This technique may be used in combination with other sensors. For example, multiple sensors may be used under each checkbox; one at the highest point, one at the lowest point, and one or more between them.

An alternate design employs sensors in a matrix pattern under the checkbox. For example, four sensors placed in a two-by-two arrangement. In this design, the apparatus can determine that each quadrant has been marked.

A more complex test for proper filling of the checkbox is required when the invention is free-standing, but is redundant when the invention is part of a larger system where the ballot is machine-checked for errors and omissions. In this case, a simpler test may be used.

The sensors used in the preferred embodiment are pressure-sensitive contacts, where the electrical resistance of a dielectric material between two conductors is pressure-dependant.

However, other types of sensors may be used; including, but not limited to:
1. Hall effect
2. Membrane
3. Piezo-electric
4. Wire contact array
5. Magnetic reed switches
6. Pushbuttons
7. Mechanical switches
8. Levers, knobs, etc.
9. Trackball or computer mice
10. Joysticks

Voter's motion may be detected by other means; including, but not limited to:
1. Video oversight and analysis.
2. An X-Y device like a graphical tablet or bitpad (CAD) input device.
3. A touchscreen-based detection system, where the ballot is placed over the screen and the votes detected that way.
4. LED and photocell scanning devices or other optical system.
5. A magnetic or radio wave position-detection system.
6. A movable transparent overlay with one aperture for filling-in the checkbox. The overlay is positioned by a manually-operated compound stage similar to that used in a microfiche reader. The overlay's position generates X-Y coordinates that identify the checkbox.

The apparatus may require that a vote be made for every office. The voting machine or system offers a ‘no-choice’ or ‘none’ selection, as well as a ‘write-in’ selection, in order to unambiguously indicate the voter's intent not to choose a candidate or to write one in.

Not all tests are required in every implementation. For example, a positioning system may not detect pressure, but other tests are made.

The essence of the invention is an apparatus that registers the voter's choices by analyzing the voter's actions while he/she is voting.

In its preferred embodiment, the apparatus does the monitoring in a passive way as a ballot is created. However, an active method of monitoring may also be used. In active monitoring, the voter is required to confirm intent through specific deliberate actions, beyond those required in a casual, simple, or perfunctory vote. Active and passive monitoring are not mutually-exclusive. The apparatus may employ either, or both in combination. Furthermore, an actual ballot may or may not be created in the process.

Such an implementation is a variation wherein the apparatus is used to accept normal input from the existing devices in a conventional voting machine, and retrofit the machine to perform analysis. One example is to require and then detect rapid repeated motion of a lever or repeated touching of a touchscreen within a specified timeframe. Another example is detection of continued depression of the lever, sustained pressure of a stylus, or continuous touch on a touchscreen over a prescribed duration of time. A third example employs a predetermined pattern of lever actuations or touchscreen touches within a short period of time.

Other tests are possible; for example, multiple inputs (more than one lever or touches) may be required (alternating, simultaneous, or a combination of both) within the specified time window in order to insure that the vote is uniquely entered and/or confirmed. Other methods of input are possible; for example, discrete sensors, bitpad tablets, electro-mechanical controls, position-detecting devices, trackballs, pushbuttons, manual switches, joysticks, etc.

One implementation may present a paper ballot to the voter, and require him/her to enter a choice via a checkbox; but may also present the candidates again on the same ballot in a different orientation, using another group of checkboxes. The voter must fill in another checkbox to confirm the vote. This is analogous to the technique used in psychological testing, wherein the same question is asked again in a restated form in order to establish consistency and unambiguously confirm intent. The apparatus then outputs the proper signals to the voting machine or system, replacing conventional direct-input devices.

Another implementation is a new voting machine that uses conventional input devices to generate signals that are analyzed by the apparatus and then processed by conventional means. That is, an otherwise conventional machine that employs the apparatus to test and/or confirm voter's intent.

In yet another implementation, a ballot may be used in combination with mechanical input devices and the vote must be entered both by ballot marking and mechanical input.

The scope of the invention is not intended to be dependent upon a particular type or pattern of input, nor is it specific to any particular methodology of analysis. The invention specified herein is defined as any apparatus that accepts voter input and analyzes it qualitatively to establish and/or confirm conscious, deliberate, and unambiguous intent on the part of the voter.

This invention ensures that the vote is:

AUTHENTIC: The ballot is created directly by the voter, and not by any other secondary or indirect means.

INTENTIONAL: Because the device monitors the voter's actions, intent is demonstrated. If the ballot is pre-marked or altered, the system ignores the alterations, because the voter's hand motions, not the markings, themselves, are the primary source of data.

DELIBERATE: Because a significant pressure and/or repeated motion within a short time frame are required, the voter's choice is shown to be deliberate.

ACCURATE: The invention provides a system wherein the voter, him/herself, actually creates the hard-copy record in the form of a ballot. Therefore, the invention provides a method of ensuring that the voter is casting a vote that is accurate.

UNAMBIGUOUS: Because of the pressure-over-time nature of the system, the vote is shown to be unambiguous. The device will not accept a checkbox marked incompletely, lightly, or casually.

Additionally, the ballot markings may be mechanically read and compared to the previously-obtained data, in order to detect tampering, poorly-marked checkboxes, errors and/or omissions. A new ballot can then be made on the spot.

This is not a specific requirement of the device and is not part of the invention, per se; but is an added feature possible when the device is used as part of a comprehensive system.

Another feature of a larger system is the ability to confirm that the unique identifying number manually entered into the ballot by the voter through a group of checkboxes is correctly entered.

Where legally permitted, the system may maintain the voter's ID number, the electronic vote data, and the unique ballot identifier number. In this way, the ballot number and data of each ballot may be checked against the actual ballot markings; and if there is a discrepancy, the voter can be found and the vote authenticated. Extra ballots, missing ballots, altered ballots; and changed or lost data can be detected.

The following embodiments are among those encompassed by the Voting Machine invention disclosed within this patent application.

1. A machine that senses the voter's motions while a paper ballot is filled out sufficient to accurately determine his/her vote, where such a machine may also include one or more of the following features in combination:

(1) It presents a simple paper ballot to the voter; and the voter, not any mechanical device, directly generates the paper record.

(2) It generates electronic data automatically, instantly, simultaneously, and directly from the voter's actions, not indirectly from the markings on the ballot.

(3) It requires that the vote is directly entered by the voter, thereby ensuring that the vote is authentic.

(4) It detects and/or ignores ballots that are altered, thereby ensuring that the vote is intentional.

(5) It requires significant and repeated effort to enter the vote, thereby ensuring that the vote is deliberate.

(6) It responds directly to the voter's actions in filling out the ballot, thereby ensuring that the vote is accurate.

(7) It requires pressure over time to register the vote, thereby ensuring that the box is definitively marked and the vote is unambiguous. It checks for multiple choices when they are not allowed. It can also check for missing votes.

(8) Through the features described above, it provides a more secure and failsafe system of voting.

Optionally, a voting machine according to the present invention may also afford the following advantages in a larger system:

(9) Confirmation of unique identifying number on ballot.

(10) Comparison of ballot and recorded data in order to detect modifications, errors, and/or omissions, thus providing a more accurate and secure system of voting than those currently in use.

In addition, the following variations, specific applications, and embodiments are also contemplated as being within the scope of the present invention:

1. An apparatus that analyzes the voter's actions while the vote is being made and generates the proper signals to a voting machine or system; but where no hard-copy ballot is simultaneously created.

2. An apparatus that analyzes the voter's actions while the vote is being made using a conventional voting machine, through the utilization of the voting machine's existing input devices; and generates the proper signals to the voting machine or system in lieu of direct input from the devices.

3. A voting system utilizing a failsafe ‘no-choice’ selection option in order to make the vote unambiguous when the voter consciously chooses not to vote for any candidate.

4. A voting system utilizing a transparent overlay with apertures aligning with checkboxes on the ballot; to enable a visually-impaired or blind voter to fill out the ballot without assistance and in private, to protect the ballot from extraneous markings, and to guide the average voter in filling in the checkbox more easily and accurately.

In addition, the following features, variations, specific applications, and embodiments can be provided in a larger system utilizing this invention:

1. A voting system where the voter's identity is checked via driver's license or voter identification card, or other method against a database of eligible voters.

2. A voting system where duplicate voters are detected.

3. A voting system where the ballots are printed on demand. And where the printed ballots may include markings in other languages and/or Braille.

4. A voting system containing a computer system and video monitor, with or without input device(s), providing visual feedback to the voter, in the form of instructions, translations, error feedback, and optionally providing for interactive confirmation by the voter, etc.

5. A voting system where the completed ballot is mechanically-read and compared to the derived data in order to detect alterations; errors, and/or omissions. Also where the legends of pre-printed ballots may be checked.

6. A voting system where duplicate, extra, or altered ballots can be detected (through ballot's unique identifier and possibly the voter ID number); and where correlation of vote data and paper ballot may be checked on a ballot-by-ballot basis. Also where errors can be corrected by contacting the original voter.

7. A voting system where a ballot containing a fatal (uncorrectable) error is shredded and a new ballot is generated.

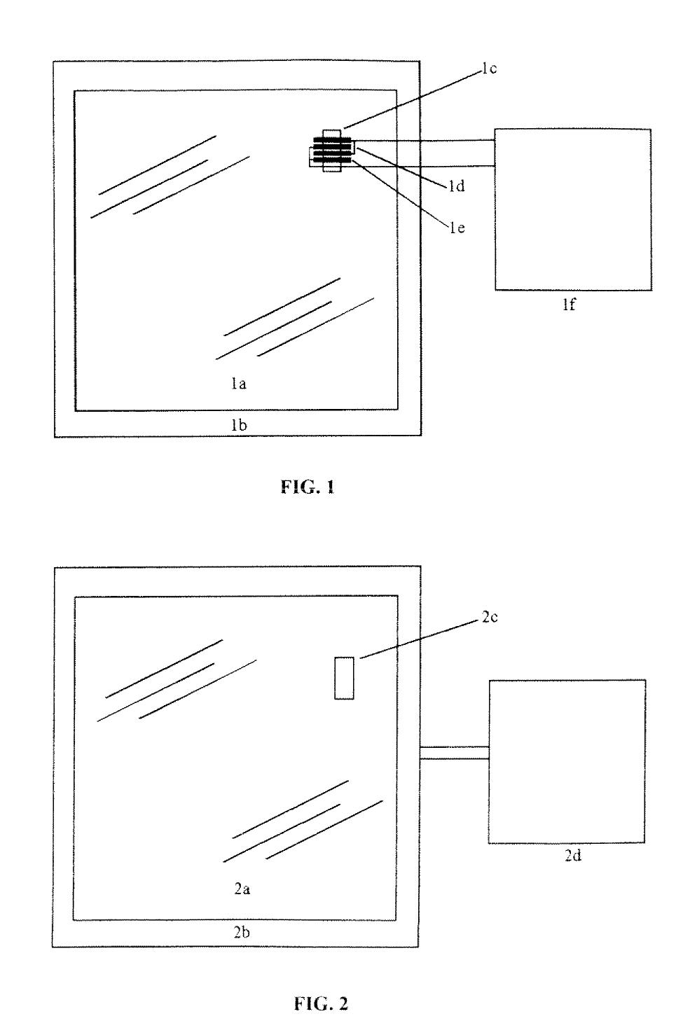

FIG. 1 shows one embodiment of the invention. In this case, the ballot (1a) is placed on a platen (1b). Sensors (1d and 1e) are embedded in the platen under a checkbox (1c) on the ballot. The ballot contains multiple checkboxes, of which one is shown here. Additional sensors (not shown) are placed under other checkboxes and operate simultaneously to register other votes. For simplicity, only one checkbox and only one set of sensors are shown in this example.

The sensors are connected to an analyzing apparatus (1f), which replaces the conventional direct input devices in a voting machine or system (not shown).

FIG. 2 shows another embodiment of the invention. In this case, the ballot (2a) is placed on a platen (2b) of a graphic tablet. The ballot contains multiple checkboxes (2c), of which one is shown. The graphic tablet feeds X-Y co-ordinates representing the position of the voter's marking device (not shown) and the amount of pressure exerted to a computer system (2d), that is either the actual vote processing system or communicates with the vote processing system to enter the vote.

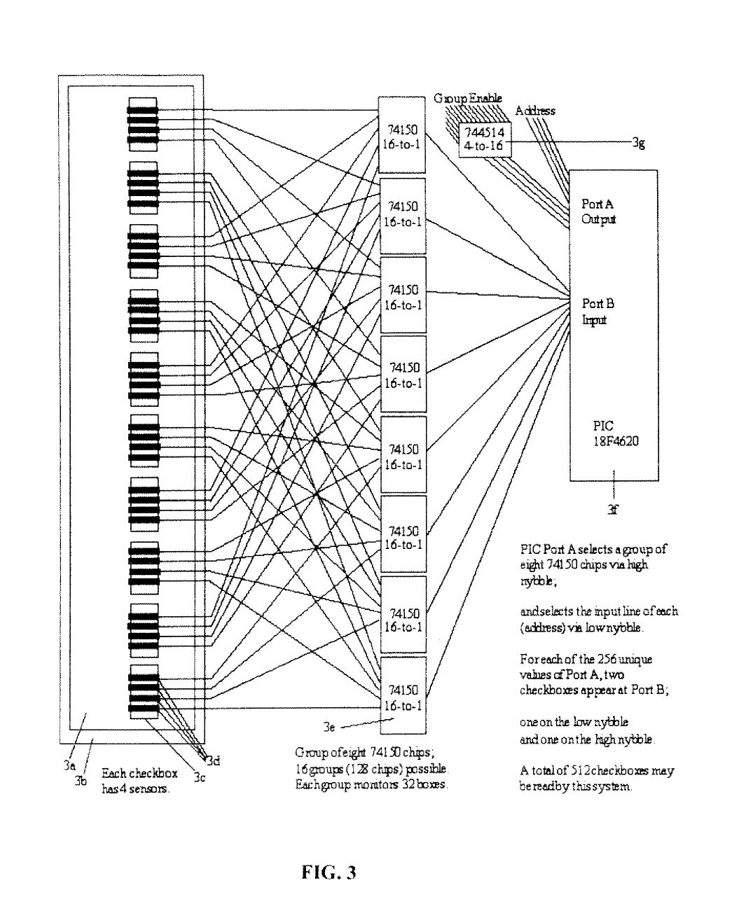

FIG. 3 shows a schematic representation of one possible implementation of the embodiment shown in FIG. 1. The ballot (3a) is placed on a platen (3b). Multiple checkboxes (3c) on the ballot are aligned over sensors (3d) embedded in the platen.

In this embodiment, each checkbox is associated with four sensors. The top and bottom sensors are simple sensors that detect the extremes of motion of the voter while the checkbox is being filled. The middle two sensors may be serrated and interleaved as in FIG. 1; however, they are shown here as simple sensors for the sake of simplicity. The electrical wiring is the same for complex sensors as it is for simple sensors.

Each sensor generates an electrical signal when pressure is applied to it as the ballot checkbox is being filled in with a marking device, e.g. the checkbox is being blackened with a pencil or ink pen. The sensor is electrically wired to one input of one of many 16-to-1 demultiplexer integrated circuits (3e), such as the TTL 74150. These integrated circuits may be part of the platen assembly or located externally. The integrated circuits are electrically wired to a small computer or PIC programmable imbedded controller (3f), such as the PIC 18F4620, or similar device. Another integrated circuit (3g); a 4-to-16 decoder such as the TTL 744514, is also wired between the demultiplexers and the PIC.

The PIC is programmed to scan the sensors and output appropriate signals to the voting system main computer (not shown), or to control other input/output devices on its own, to indicate which checkboxes are filled in and to report any errors.

Referring again to FIG. 1, the analyzing apparatus monitors the sensors. Sensors detect the marking device used by the voter as he/she votes. The sensors are serrated and interleaved so that a vertical stroke made by the marking device as the checkbox is filled in will generate multiple alternating closures of the sensors. Alternately, multiple discrete sensors may be configured in the same way (two groups) or individually (three or more separate signals). In order to fill-in the checkbox, multiple strokes must be made and pressure must be applied. This creates a data stream of pulses over a period of time. When the analyzing apparatus detects continual closures or activations of the sensors in rapid alternation within a discrete window of time, it registers the vote.

Referring to FIG. 2, the computer system constantly monitors the position of the voter's marking device. When it detects rapid continual motion under pressure confined to the area of a checkbox and lasting for a minimum amount of time, it registers the vote. The minimum amount of time for the rapid continual motion under pressure, and the minimum pressure in implementations where a minimum pressure criterion is used to ensure the choice is deliberate, to be applied to the sensors under each checkbox that would be required for the choice or vote to be registered can be readily determined experimentally and would correspond to those parameters as measured when a checkbox is completely and heavily filled in or blackened. It is expected that the minimum amount or duration of time will be in the range of at least 0.5 seconds. The minimum amount of time will vary depending on the size of the checkbox, and higher values selected for the minimum amount of time would result in higher confidence in the accuracy and intentional nature of the vote. However, values that are too long such that they would result in the waste of the voter's time should be avoided. An individual timed while filling in a couple of check boxes of different but common sizes, filled in the check boxes in 3 seconds and 5 seconds, respectively. It is therefore expected that the more useful values for the minimum amount of time will be in the range of 2 seconds or greater, and that the most useful will be in the range of 3 seconds or greater. 7 seconds would seem to be a reasonable upper bound for the useful values of the minimum amount of time that is to be programmed into the voting apparatus of the present invention.

When used as a stand-alone device, the invention should monitor pressure applied by the marking device as well as its range of motion. This is to ensure that the checkbox is marked firmly and completely. When the invention is used as part of a larger system, the completed ballot is read and compared to the registered votes in order to detect errors and omissions. A test for pressure is redundant, because lightly-marked or partially marked checkboxes will be flagged when the ballot is read, and the voter will be required to correct the error.

Referring to FIG. 3, the sensors under each checkbox are each wired to one input of each of 4 demultiplexer IC chips, at the same address on each chip. When the 4 demultiplexer chips are set to the proper address (and enabled), the signals from the four checkbox sensors appear in parallel at the high or low nibble of the PIC's 8-bit standard input port. The PIC can then read the sensors of that checkbox.

The demultiplexers are wired in groups of eight, so two checkboxes may be read simultaneously. One appears on the high nibble of the PIC's input port and the other on the low. Each demultiplexer chip can read 16 different inputs (selected by the chip's address setting), so each group can monitor 16 pairs of checkboxes, or 32 checkboxes. The demultiplexers are set to an address by electrical connection to the low nibble of the PIC's standard 8-bit output port. All demultiplexers are addressed in parallel (all are set to the same address at the same time).

Each individual group of eight demultiplexers is selected by the PIC's output port high nibble data, which is fed through a 4-to-16 decoder to power 16 individual enable lines, each line electrically wired to enable the eight demultiplexer chips in one particular group. There are 16 groups possible, and each group can monitor 16 checkbox pairs, so as many as 512 checkboxes may be scanned, two at a time.

For simplicity, only one group is shown, and only 10 of its checkboxes are shown.

The PIC scans the checkboxes under software control and interprets the sensor activity to determine which checkboxes are filled in properly and what errors exist (if any). The data may be output to a voting system computer or processed internally. The PIC can operate display, printing, I/O, and/or data storage devices (magnetic, such as hard drive; optical, such as CD ROM; or unalterable, such as punched tape or cards; etc.).

In summation, this invention pertains to an apparatus that monitors the voter's actions while he or she fills out a paper ballot, with tests for applied pressure, rapid and deliberate motion, and range of motion, within a limited time frame and designated area; thereby generating both the hard-copy record and electronic data directly and simultaneously from the voter's hand motion and documenting the voter's intent.

Optionally, as part of a larger system, it may also compare the electronic data to the actual markings on the ballot.

This insures that a paper record is generated, that it is created by the voter, that the ballot is not altered before or after the voter marks it, that the ballot is marked firmly and repeatedly and with pressure, that there are not missing or multiple choices, that the ballot and data record justify, that the vote is therefore authentic, accurate, intentional, deliberate, and unambiguous.

When this invention is part of a larger system, additional safeguards and global advantages may be achieved.

The invention may be used to augment or replace the input devices (such as levers and switches) in a conventional system that may or may not create a paper ballot. When used to determine the voter's intent through analysis of the voter's specific and deliberate actions, the apparatus can establish and/or confirm integrity of the vote without requiring the creation of a paper ballot.

In addition, the invention includes a method for ensuring that votes cast reflect the true intent of the voter by monitoring the voter's actions, e.g. hand motion, during the voting process, with tests for applied pressure, rapid and deliberate motion, and range of motion, within a limited time frame and designated area.

It should be noted that “checkbox” as used herein can be rectangular, oval, circular, or any other suitable shape.

This invention is not limited to the embodiments disclosed above, and includes any and all embodiments within the scope of the appended claims and their equivalents.

1. A voting apparatus comprising:
monitoring means for monitoring the motions of a voter indicative of a choice being made by the voter, said monitoring means generating an output signal corresponding to the motions of the voter; and
testing means for testing said output signal with respect to meeting at least one predetermined criterion corresponding to at least one characteristic of the motions of the voter,
wherein for said output signal to meet said at least one predetermined criterion, the motions of the voter would be required to entail significant and continuous or repeated effort to ensure that the choice of the voter is deliberate, and
wherein when said output signal meets said at least one predetermined criterion, the choice of the voter is registered by said testing means.

2. The voting apparatus according to claim 1, wherein said at least one criterion corresponds to one or more of the characteristics of the motions of the voter selected from the group consisting of position, duration, repetition, pressure, and time frame.

3. The voting apparatus according to claim 1, wherein said monitoring means comprises:
a platen for supporting a ballot,
wherein the motions of the voter sensed by said monitoring means correspond to the voter's hand motions while a checkbox in the ballot is filled out, such that both electronic data indicative of the voter's choice and a permanent record of the voter's choice in the form of the ballot are simultaneously produced.

4. The voting apparatus according to claim 3, wherein said monitoring means generates a signal corresponding to the position of a marking device held by the voter over said platen, and wherein said output signal meets said at least one criterion when the position of the marking device is determined to be confined to a predetermined region of said platen for a predetermined duration of time.

5. The voting apparatus according to claim 1, wherein said monitoring means comprises:
a platen for supporting a ballot;
at least one sensor provided in said platen at a position corresponding to a checkbox on the ballot, wherein said output signal of said monitoring means is indicative of pressure applied to said checkbox by the voter using a marking device,
thereby simultaneously producing electronic data indicative of the voter's choice and a permanent record of the voter's choice in the form of the ballot.

6. The voting apparatus according to claim 5, wherein said output signal meets said at least one criterion when the pressure applied to said checkbox remains above a predetermined threshold for at least a predetermined duration of time.

7. The voting apparatus according to claim 1, wherein said monitoring means comprises:
a platen for supporting a ballot;
at least one sensor array provided in said platen at a position corresponding to a checkbox on the ballot, wherein said sensor array is responsive to pressure applied to said checkbox by the voter using a marking device, wherein said output signal of said monitoring means is indicative of pressure applied to said checkbox by the voter using the marking device,
thereby simultaneously producing electronic data indicative of the voter's choice and a permanent record of the voter's choice in the form of the ballot.

8. The voting apparatus according to claim 7, wherein said output signal meets said at least one criterion when said output signal fluctuates multiple times above and below an average level for at least a predetermined duration of time.

9. The voting apparatus according to claim 1, wherein the motions of the voter sensed by said monitoring means correspond to the voter's hand motions while holding a marking device, and wherein said output signal meets said at least one criterion when the position of the marking device is determined to be confined to a predetermined region of space for a predetermined duration of time.

10. The voting apparatus according to claim 9, wherein said monitoring means comprises said marking device, and wherein said marking device includes at least in part a device selected from the group consisting of a pen, pencil, stylus, pointer, trackball, computer mouse, joystick, and a manually-operated compound stage.

11. The voting apparatus according to claim 1, wherein said testing means is programmable and is programmed with said at least one criterion.

12. The voting apparatus according to claim 11, wherein said at least one criterion is a predetermined duration of time over which said output signal from said monitoring means has a specified characteristic.

13. The voting apparatus according to claim 11, wherein the motions of the voter sensed by said monitoring means correspond to the voter's hand motions while holding a marking device, and wherein said output signal meets said at least one criterion when the position of the marking device is determined to be confined to a predetermined region of space for a predetermined duration of time.

14. The voting apparatus according to claim 13, wherein said monitoring means comprises said marking device, and wherein said marking device includes at least in part a device selected from the group consisting of a pen, pencil, stylus, pointer, trackball, computer mouse, joystick, and a manually-operated compound stage.

15. The voting apparatus according to claim 3, further comprising a transparent overlay with apertures aligning with checkboxes on the ballot.

16. The voting apparatus according to claim 3, further comprising a printer that allows ballots to be printed on demand.

17. The voting apparatus according to claim 3, further comprising a computer system and monitor that provide visual feedback to the voter.

18. The voting apparatus according to claim 3, further comprising a scanner for reading the ballot to thereby allow the ballot to be compared to the corresponding electronic data in order to detect any inconsistency between the ballot and the electronic data.

19. The voting apparatus according to claim 17, further comprising a scanner for reading the ballot to thereby allow the ballot to be compared to the corresponding electronic data in order to detect any inconsistency between the ballot and the electronic data.

20. A method of voting comprising the steps of:
providing a voting machine having means for recording a vote by a voter, with the machine being configured such that the correct voting procedure using the voting machine entails motions or actions by the voter that require significant and repeated or continuous effort;
requiring the voter to perform the correct voting procedure before the vote is registered, thus requiring the voter to perform motions or actions that require significant and repeated or continuous effort before the vote is registered;
monitoring the voter's motions or actions during the voting process; and
registering the vote if the voter's motions or actions during the voting process are consistent with the correct voting procedure, thereby ensuring that the vote truly reflect the voter's intent.

21. The method of voting according to claim 20, wherein said step of requiring the voter to perform the correct voting procedure comprises the steps of:
requiring the voter to make a choice by entering his or her choice into the voting machine; and
requiring the voter to confirm his or her choice by entering his or her choice into the voting machine at least one more time.

22. The method of voting according to claim 20, further comprising the steps of:
providing a ballot to the voter with at least one checkbox that must be filled in before the vote is registered;
monitoring the voter's motions or actions simultaneously with the voter's filling in of the checkbox;
registering the vote if the voter's motions or actions are consistent with the voter's filling in of the checkbox, such that a permanent record of the vote is created in the form of the ballot simultaneous with the registering of the vote by the machine.
